(19) United States
(12) Patent Application Publication
(10) Pub. No.: US 2016/0321854 A1
(43) Pub. Date: Nov. 3, 2016

(54) VALUABLE MEDIUM HANDLING SYSTEM AND VALUABLE MEDIUM HANDLING METHOD

(71) Applicant: GLORY LTD., Himeji-shi (JP)

(72) Inventor: Koji MIZUMOTO, Hyogo (JP)

(73) Assignee: GLORY LTD., Himeji-shi (JP)

(21) Appl. No.: 15/107,639

(22) PCT Filed: Dec. 22, 2014
(86) PCT No.: PCT/JP2014/083838

§ 371 Date: Jun. 23, 2016

(30) Foreign Application Priority Data
Dec. 24, 2013 (JP) 2013-265816

(51) Int. Cl. G07D 11/00

(52) U.S. Cl. CPC G07D 11/0084

(57) ABSTRACT

A valuable medium handling system configured to handle paper sheets includes a recognition unit 55 configured to recognize and count the valuable medium, and a display unit configured to display count information resulted from counting of the valuable medium by the recognition unit 55. If at least a part of the count information has not been displayed on the display unit, a notice of undisplayed count information is provided.

### TECHNICAL FIELD

The present invention relates to valuable medium handling systems and valuable medium handling methods for handling valuable media such as banknotes, coins, checks, gift certificates, barcode tickets, chips, and coins.

### BACKGROUND ART

Valuable medium handling systems for handling valuable media have conventionally been known. WO 2009/069197 discloses an example of a paper sheet handling machine for handling paper sheets. The paper sheet handling machine disclosed in WO 2009/069197 includes a taking-in unit configured to take in, one by one, paper sheets such as the first currency banknotes, the second currency banknotes or barcode tickets, a transport unit configured to transport the taken-in paper sheets, a recognition unit configured to recognize the paper sheets being transported by the transport unit, a stacking unit configured to stack the paper sheets transported by the transport unit, and a display unit configured to display information on the paper sheets stacked in the stacking unit. The display unit includes the first display unit configured to display predetermined information, and the second display unit configured to display information other than the predetermined information. The first display unit switches between a display of the number of barcode tickets, the denominations of Hong Kong dollar banknotes (first currency banknotes), and the number of banknotes for each denomination, and a display of the denominations of Macanese pataca banknotes (second currency banknotes) and the number of banknotes for each denomination.

### DISCLOSURE OF THE INVENTION

According to WO 2009/069197, information on each currency can be obtained by simply switching between the displays on the first display unit. This is very beneficial. However, sometimes two or more currencies are mixed while the operator is unaware of the mixture, and the mixed currencies are recognized by the paper sheet handling machine. In this case, the transaction of the mixed currencies may be accepted without being subjected to visual inspection by the operator with respect to information on the mixed currencies (for example, information on the number of banknotes for each denomination of each of the mixed currencies), and the process may proceed to the next step.

Even if only one currency in various denominations is handled, there is a case where the counts of the number of banknotes for all the denominations cannot be displayed on a display unit at a time due to too many denominations. In this case, there is a problem similar to the aforementioned problem, in which a transaction may be accepted without being visually confirmed by the operator with respect to information on undisplayed denominations (for example, the count information on the counts of the number of banknotes for some denominations), and the process may proceed to the next step.

In view of the aforementioned circumstances, the present invention provides a valuable medium handling system and a valuable medium handling method, which prevent a transaction from being accepted without the operator's awareness of such information as needs to be visually confirmed by an operator.

A valuable medium handling system according to the present invention is a valuable medium handling system configured to handle a valuable medium, including:

a recognition unit configured to recognize and count the valuable medium; and

a display unit configured to display count information resulted from counting of the valuable medium by the recognition unit,

wherein if at least a part of the count information has not been displayed on the display unit, a notice indicating undisplayed count information is provided.

In the present invention, if at least a part of the count information has not been displayed on the display unit, the valuable medium handling system provides a notice indicating undisplayed count information. Therefore, an operator may become aware of undisplayed count information that needs to be visually confirmed. Therefore, according to the present invention, it is possible to prevent an operator from starting the next process by accepting a current transaction without noticing undisplayed count information that has not been displayed on the display unit.

In the valuable medium handling system according to the present invention, if at least a part of the count information has not been displayed on the display unit, guidance information used to display undisplayed count information on the display unit may be displayed on the display unit.

In the valuable medium handling system according to the present invention, if at least a part of the count information has not been displayed on the display unit, character information notifying of the presence of undisplayed count information may be displayed.

In the valuable medium handling system according to the present invention, the count information may include information on the currency counted by the recognition unit.

In the valuable medium handling system according to the present invention, the count information may include information on the number of banknotes for each denomination of the currency counted by the recognition unit.

In the valuable medium handling system according to the present invention, information on the currency counted by the recognition unit may be displayed on the display unit in a different manner from information on the currency not counted by the recognition unit.

In the valuable medium handling system according to the present invention, the count information may include information on denominations of money counted by the recognition unit.

In the valuable medium handling system according to the present invention, the count information may include information on the number of banknotes for each denomination of the money counted by the recognition unit.

In the valuable medium handling system according to the present invention, information on the number of banknotes for each denomination counted by the recognition unit may be displayed on the display unit in a different matter from information on the number of banknotes for each denomination not counted by the recognition unit.

In the valuable medium handling system according to the present invention, if at least a part of the count information has not been displayed on the display unit, auxiliary information including a content that is not included in the count information, or having an aspect that is different from that of the count information may be displayed on the display unit.

The valuable medium handling system according to the present invention further includes an input unit for inputting acceptance of a transaction, wherein if at least a part of the count information has not been displayed on the display unit, and the acceptance of the transaction is inputted from the input unit, a notice indicating the presence of undisplayed count information is provided.

In the valuable medium handling system according to the present invention, if the acceptance of the transaction is inputted from the input unit after the notice indicating the presence of undisplayed count information is provided, the transaction may be accepted despite the presence of the undisplayed count information.

In the valuable medium handling system according to the present invention, if the transaction is accepted despite the presence of the undisplayed count information, a notice of acceptance may be displayed on the display unit.

The valuable medium handling system according to the present invention may further include an input unit for inputting acceptance of a transaction, wherein if at least a part of the count information has not been displayed on the display unit, the acceptance of the transaction may be rejected, which indicates that the part of the count information has not been displayed on the display unit.

The valuable medium handling system according to the present invention may further include a switching unit having a first mode in which an input from the input unit relating to acceptance of a transaction is not accepted if at least a part of the count information has not been displayed on the display unit, and a second mode in which an input from the input unit relating to acceptance of the transaction is accepted even if at least a part of the count information has not been displayed on the display unit.

In the valuable medium handling system according to the present invention, if there is undisplayed count information in the second mode, and the input relating to acceptance of the transaction is accepted, a notice of acceptance may be displayed on the display unit.

A valuable medium handling method according to the present invention is a valuable medium handling method for handling a valuable medium, including:

recognizing and counting the valuable medium by a recognition unit;

displaying, by a display unit, count information resulted from counting of the valuable medium by the recognition unit; and

providing a notice if at least a part of the count information has not been displayed on the display unit.

### BRIEF DESCRIPTION OF THE DRAWINGS

FIG. 1 is a perspective view illustrating an external appearance of a paper sheet handling machine (valuable medium handling machine) according to an embodiment of the present invention.

FIG. 2 is a schematic configuration diagram illustrating an internal configuration of the paper sheet handling machine according to the embodiment of the present invention.

FIG. 3 is a control block diagram illustrating a configuration of the paper sheet handling machine according to the embodiment of the present invention.

FIG. 4(a) is a diagram illustrating an example of a first aspect of a display on an operation display screen of a operation/display unit of the paper sheet handling machine according to the embodiment of the present invention.

FIG. 4(b) is a diagram illustrating the display on the operation display screen after “CNY” is selected in FIG. 4(a) and the number of banknotes for each denomination of Chinese yuan is displayed on the operation display screen.

FIG. 5 is a diagram illustrating another example of the first aspect of the display on the operation display screen of the operation/display unit of the paper sheet handling machine according to the embodiment of the present invention.

FIG. 6 is a diagram illustrating a further example of the first aspect of the display on the operation display screen of the operation/display unit of the paper sheet handling machine according to the embodiment of the present invention.

FIG. 7 is a diagram illustrating an example of a second aspect of a display on the operation display screen of the operation/display unit of the paper sheet handling machine according to the embodiment of the present invention.

FIG. 8 is a diagram illustrating an example of a third aspect of a display on the operation display screen of the operation/display unit of the paper sheet handling machine according to the embodiment of the present invention.

FIG. 9 is a diagram illustrating another example of the third aspect of the display on the operation display screen of the operation/display unit of the paper sheet handling machine according to the embodiment of the present invention.

FIG. 10 is a diagram illustrating an example of a fourth aspect of a display on the operation display screen of the operation/display unit of the paper sheet handling machine according to the embodiment of the present invention.

FIG. 11 is a diagram illustrating a state where only information on the currency counted by a recognition unit is displayed on the operation display screen of the operation/display unit of the paper sheet handling machine according to the embodiment of the present invention.

FIG. 12 is a diagram illustrating a state where only information on denominations of banknotes counted by the recognition unit is displayed on the operation display screen of the operation/display unit of the paper sheet handling machine according to the embodiment of the present invention.

FIG. 13 is a diagram illustrating a state where a paper sheet handling system (valuable medium handling system) according to the embodiment of the present invention includes an imaging unit, a memory unit, and an image display unit.

FIG. 14 is a diagram illustrating a state where the valuable medium handling system according to the embodiment of the present invention includes an external machine such as a personal computer and a tablet terminal, including an external input unit, an external display unit, and an external memory unit.

FIG. 15 is a diagram illustrating a state where the valuable medium handling system according to the embodiment of the present invention includes a plurality of paper sheet handling machines, a plurality of external machines, and a server.

FIG. 16(a) is a diagram illustrating another aspect of the display on the operation display screen of the operation/display unit of the paper sheet handling machine according to the embodiment of the present invention.

FIG. 16(b) is a diagram illustrating a display changed from the display illustrated in FIG. 16(a).

### BEST MODE FOR CARRYING OUT THE INVENTION

### Embodiments

### Configuration

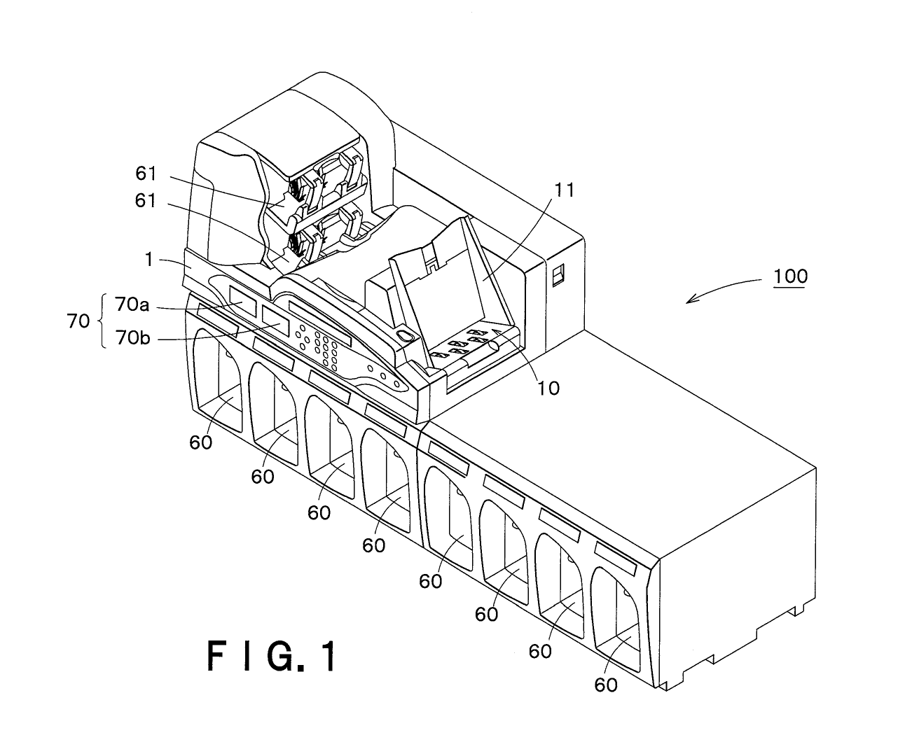

Hereinafter, embodiments of a valuable medium handling system and a valuable medium handling method according to the present invention will be described with reference to the accompanying drawings. FIGS. 1 to 15 are drawings for explaining the embodiments of the present invention.

In the present invention, a “valuable medium handling system” may include a single “valuable medium handling machine.” Therefore, the “valuable medium handling system” recited in the claims may mean a valuable medium handling machine itself, and also a combination of a valuable medium handling machine and another machine. The scope of “valuable medium” in the present invention includes all monetarily valuable things, such as banknotes, coins, checks, gift certificates, barcode tickets, chips, and coins. Banknotes and coins are typical examples. The “money” in the present invention means banknotes and/or coins. It should be noted that although banknotes will be mainly described as valuable media and a paper sheet handling machine (typically a banknote handling machine) will be described as a valuable medium handling machine in the following descriptions, they are mere examples.

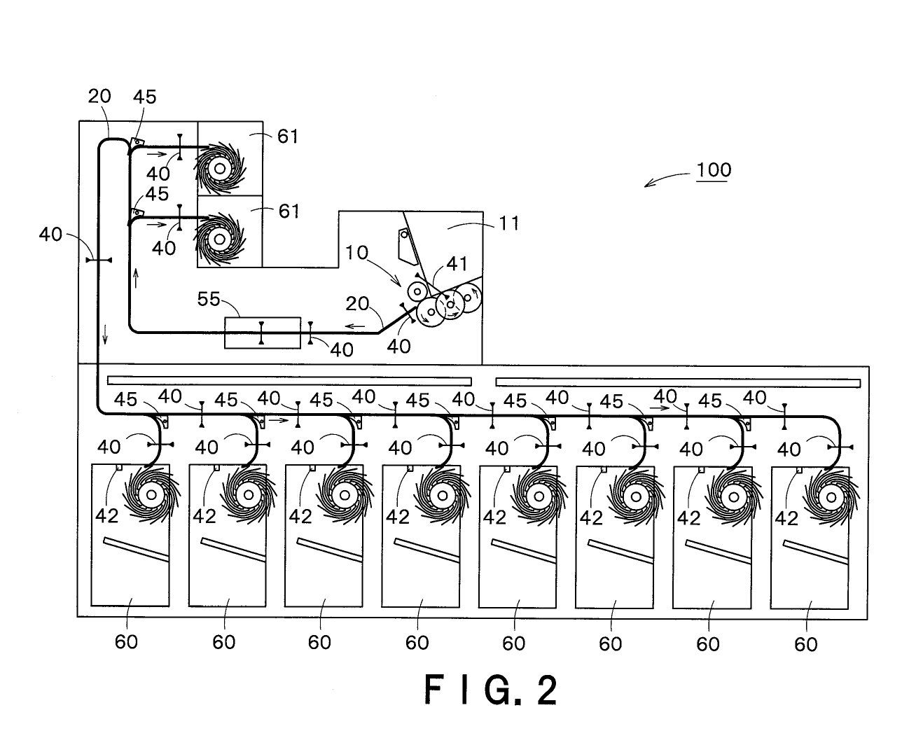

FIG. 1 shows that a paper sheet handling machine 100 according to an embodiment includes a housing 1, a reception unit 11 put in the housing 1 and configured to receive a plurality of banknotes, and a taking-in unit 10 configured to take in, one by one, the lowermost banknote of stacked banknotes that are received by the reception unit 11. FIG. 2 shows that the paper sheet handling machine 100 includes a transport unit 20 configured to transport each of the banknotes taken in by the taking-in unit 10 into the housing 1, and a recognition unit 55 configured to recognize the banknotes transported by the transport unit 20 and count the number of the banknotes. The paper sheet handling machine 100 further includes a plurality of (eight in FIGS. 1 and 2) stackers 60 in which the banknotes recognized by the recognition unit 55 are stacked, and a plurality of (two in FIGS. 1 and 2) rejection units 61 configured to reject banknotes that are not stacked in the stackers 60. The recognition unit 55 in this embodiment recognizes, for example, denomination, fitness, face/back, version, orientation, and authentication of banknotes. The paper sheet handling machine 100 is installed in, for example, financial institutions such as banks, and banknote handling centers.

As shown in FIG. 1, a front portion (the front side in FIG. 2) of each of the stackers 60 has an opening, through which an operator may freely take out the banknotes in the stackers 60. Although the embodiment includes a stacker unit composed of eight stackers 60, the stacker unit is not limited to this description. The number of the stackers 60 may be freely increased or decreased in the stacker unit. For example, if a stacker unit including four stackers 60 is eliminated, a paper sheet handling machine 100 including four stackers 60 may be provided, and if a stacker unit including four stackers 60 is added, a paper sheet handling machine 100 including 12 stackers 60 may be provided.

FIG. 2 shows that the transport unit 20 includes a plurality of tracking sensors 40 for sensing banknotes conveyed by the transport unit 20. The transport unit 20 also includes a plurality of diverters 45 for diverting the banknotes conveyed by the transport unit 20. The reception unit 11 includes a presence detection sensor 41 configured to detect whether there is a banknote in the reception unit 11, and each of the stackers 60 includes a presence detection sensor 42 configured to detect whether there is a banknote in the stacker 60. Old-version banknotes and new-version banknotes of the same denomination may be stacked in different stackers 60, and banknotes of the same denomination with different orientations may be staked in different stackers 60. Alternatively, all of banknotes of the same denomination may be stacked in the same stacker 60.

The paper sheet handling machine 100 may also include one or more banknote bundling units configured to bundle the banknotes, although it is not shown in the drawings. The banknote bundling unit includes a plurality of banknote-to-be-bundled stacking units in which banknotes to be bundled conveyed by the transport unit 20 are stacked, a bundling unit configured to bundle the banknotes stacked in the banknote-to-be-bundled stacking units with a bundle band to make a banknote batch, a paper sheet batch stacking unit configured to stack paper sheet batches bundled by the bundling unit, and a batch outlet through which the paper sheet batches stacked in the paper sheet batch stacking unit are released. The aforementioned bundling unit makes a paper sheet batch by wrapping a bundle band around 100 paper sheets, for example, and fastening the bundle band to bundle the paper sheets.

The paper sheet handling machine 100 may also include a banknote reversing unit with a banknote reverser configured to reverse the banknotes, although the banknote reversing unit is not shown in the drawings. The banknote reverser includes a short edge reverser and a long edge reverser. The short edge reverser reverses the face and the back of a banknote so that the orientation of the short edge is reversed while the transport unit 20 transports the banknotes in a long-edge orientation, and the long edge reverser reverses the face and the back of a banknote so that the orientation of the long edge is reversed while the transport unit 20 transports the banknotes.

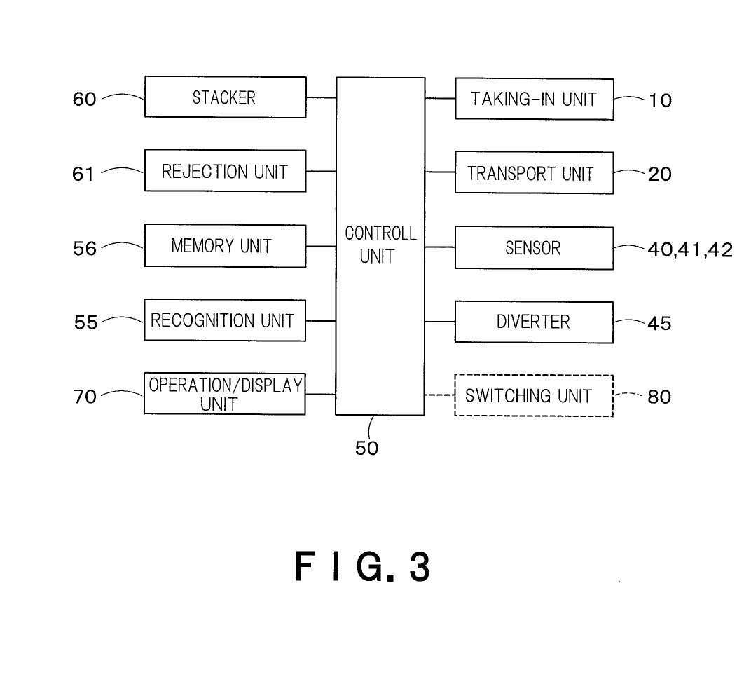

FIG. 3 shows that the paper sheet handling machine 100 also includes a control unit 50 configured to control respective components of the paper sheet handling machine 100, a memory unit 56 configured to store various kinds of information, and an operation/display unit 70 (corresponding to the “display unit” and the “input unit” in the claims). The operation/display unit 70 displays at least count information based on the result of counting the number of banknotes (valuable media) by the recognition unit 55. As shown in FIG. 1, in this embodiment, the operation/display unit 70 is disposed on the front side of the housing 1 and includes two operation display screens 70a and 70b. One of the operation display screens displays contents that will be described later. The operation/display unit 70 does not necessarily include two operation display screens 70a and 70b, but may include only one operation display screen, or three or more operation display screens. Each of the operation display screens 70a and 70b included in the operation/display unit 70 of the embodiment is a touch panel. Signals are sent to the control unit 50 when an operator touches buttons etc. displayed on the operation display screens 70a and 70b. In the descriptions of the embodiment, the operation/display unit 70 has the functions of the “display unit” and the “input unit.” However, the aspect of the embodiment is not limited to this description, and the “display unit” and the “input unit” may be separate components, and for example, the “input unit” may be disposed on the side surface of the housing 1, independently of the “display unit.”

In the embodiment, the taking-in unit 10, the transport unit 20, the sensors 40, 41, and 42, the diverters 45, the stackers 60, the rejection units 61, the memory unit 56, the recognition unit 55, and the operation/display unit 70 are connected to the control unit 50, as shown in FIG. 3. The control unit 50 controls these components, and obtains information from these components.

Next, the contents of the display on the operation display screen 70a or the operation display screen 70b of the operation/display unit 70 will be described below.

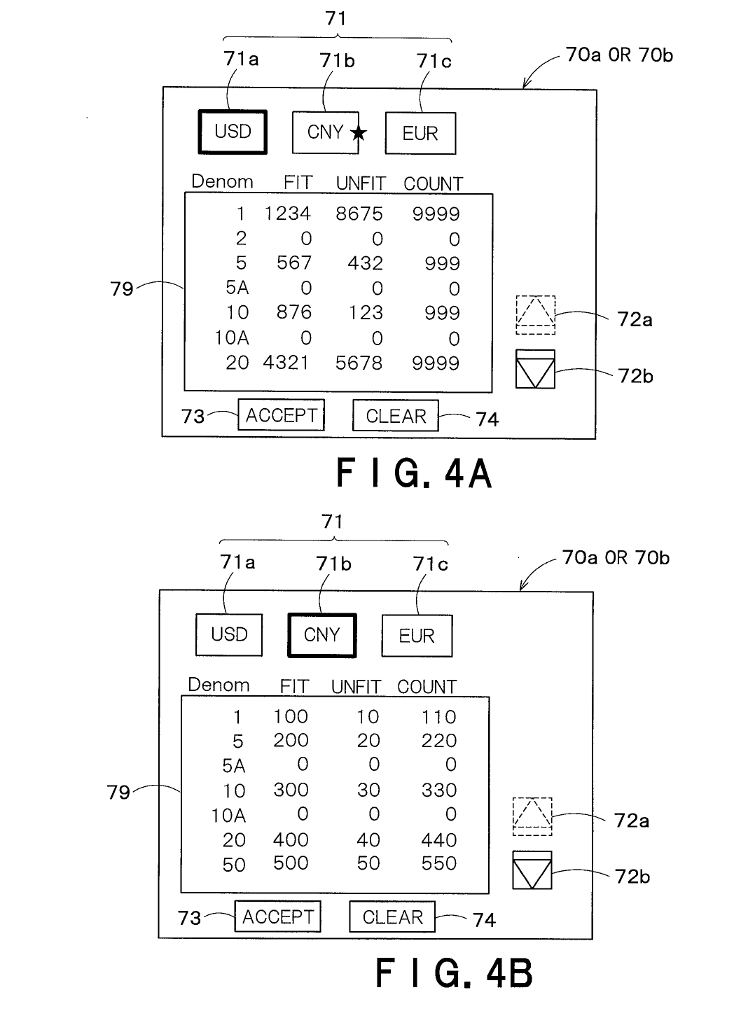

FIG. 4(a) shows a state where the operation/display unit 70 displays buttons 71 for switching between the displays of currencies, and a window 79 showing count information for each denomination. Namely, the window 79 shows the number of banknotes for each denomination of a currency, and the number of fit notes (FIT) and the number of unfit notes (UNFIT) in the banknotes for each denomination. The buttons 71 for switching between the displays of currencies include a button 71a for displaying information on US dollar (USD), a button 71b for displaying information on Chinese yuan (CNY), and a button 71c for displaying information on Euro (EUR). The operation/display unit 70 also displays an upward arrow 72a, a downward arrow 72b, an “ACCEPT” button 73, and a “CLEAR” button 74. The contents displayed on the window 79 showing count information for each denomination can be scrolled upward by pressing down the upward arrow 72a, and downward by pressing down the downward arrow 72b. A transaction can be accepted by pressing the “ACCEPT” button 73, and the contents displayed on the window 79 showing count information for each denomination can be erased by pressing down the “CLEAR” button 74.

In the state shown in FIG. 4(a), the button 71a for displaying information on US dollar (USD) is selected, and the operation/display unit 70 displays the number of US dollar (USD) banknotes for each denomination, and the number of fit notes (FIT) and the number of unfit notes (UNFIT) in the banknotes for each denomination. In the state shown in FIG. 4(a), “5A” means five-dollar old-version banknote, and “10A” means 10-dollar old-version banknote. Specifically, in the state shown in FIG. 4(a), there are 1234 one-dollar banknotes determined to be fit notes, 8675 one-dollar banknotes determined to be unfit notes. Thus, the window 79 showing count information for each denomination indicates that there are in total 9999 one-dollar banknotes. The window 79 showing count information for each denomination also displays that there is no two-dollar banknote, and that therefore, the number of two-dollar fit notes is zero, and the number of two-dollar unfit notes is zero. The window 79 showing count information for each denomination further indicates that there are 567 new-version five-dollar banknotes determined to be fit notes and 432 new-version five-dollar banknotes determined to be unfit notes, and that there are in total 999 five-dollar banknotes. The window 79 showing count information for each denomination also indicates that there is no old-version five-dollar banknote, and that therefore the number of old-version five-dollar banknotes to be determined as fit notes is zero, and the number of old five-dollar banknote determined to be unfit note is zero. The window 79 showing count information for each denomination further indicates that the number of new-version 10-dollar banknotes determined as fit notes is 876, the number of new-version 10-dollar banknotes determined as unfit notes is 123, and the total number of 10-dollar banknotes is 999. The window 79 showing count information for each denomination also indicates that the number of old-version 10-dollar banknotes is zero, and that therefore the number of old-version 10-dollar banknotes determined as fit notes is zero, and the number of old-version 10-dollar banknotes determined as unfit notes is zero. The window 79 showing count information for each denomination still further indicates that the number of 20-dollar banknotes determined as fit notes is 4321, the number of 20-dollar banknotes determined as unfit notes is 5678, and the total number of 20-dollar banknotes is 9999.

FIG. 4(b) shows a display on the operation display screens 72a or 72b after “CNY” is selected in FIG. 4(a), showing the number of Chinese yuan banknotes for each denomination. In the state shown in FIG. 4(b), the operation/display unit 70 displays the number of Chinese yuan (CNY) banknotes for each denomination, and the number of banknotes determines as fit notes (FIT) and the number of banknotes determined as unfit notes (UNFIT) in the total banknotes. Also in the state shown in FIG. 4(b), “A” means old-version note, and therefore “5A” means old-version five-yuan banknote, and “10A” means old-version 10-yuan banknote. Specifically, in the state shown in FIG. 4(b), the window 79 showing count information for each denomination indicates that the number of one-yuan banknotes determined as fit notes is 100, the number of one-yuan banknotes determined as unfit notes is 10, and the total number of one-yuan banknotes is 110. The window 79 showing count information for each denomination also indicates that the number of new-version five-yuan banknotes determined as fit notes is 200, the number of new-version five-yuan banknotes determined as unfit notes is 20, and the total number of new-version five-yuan banknotes is 220. The window 79 showing count information for each denomination further indicates that the number of old-version five-yuan banknotes is zero, and therefore the number of old-version five-yuan banknotes determines as fit notes is zero, and the number of old-version five-yuan banknotes determined as unfit notes is zero. The window 79 showing count information for each denomination still further indicates that the number of new-version 10-yuan banknotes determined as fit notes is 300, the number of new-version 10-yuan banknotes determined as unfit notes is 30, and the total number of new-version 10-yuan banknotes is 330. The window 79 showing count information for each denomination also indicates that the number of old-version 10-yuan banknotes is zero, and therefore the number of old-version 10-yuan banknotes determined as fit notes is zero, and the number of old-version 10-yuan banknotes determined as unfit notes is zero. The window 79 showing count information for each denomination also indicates that the number of 20-yuan banknotes determined as fit notes is 400, the number of 20-yuan banknotes determined as unfit notes is 40, and the total number of 20-yuan banknotes is 440. The window 79 showing count information for each denomination also indicates that the number of 50-yuan banknotes determined as fit notes is 500, the number of 50-yuan banknotes determined as unfit notes is 50, and the total number of 50-yuan banknotes is 550.

If the valuable media are coins, the operation/display unit 70 displays, for example, buttons for switching between the displays of currencies, a window showing count information for each denomination of the target currency, an upward arrow, a downward arrow, an “ACCEPT” button, and a “CLEAR” button, like the aforementioned case where banknotes are handled. If the valuable media are gift certificates, the operation/display unit 70 displays, for example, buttons for switching between the displays of issuer of the gift certificates, a window showing count information for each denomination of the gift certificates issued by the target issuer, an upward arrow, a downward arrow, an “ACCEPT” button, and a “CLEAR”. If the valuable media are checks, the operation/display unit 70 displays a window showing count information for each denomination, an upward arrow, a downward arrow, an “ACCEPT” button, and a “CLEAR” button.

The recognition unit 55 acquires various kinds of information on banknotes (valuable media). Herein, the “count information” means information to be displayed on the operation/display unit 70 in the information obtained from counting the number of banknotes (valuable media) performed at the recognition unit 55. In other words, the count information is main information that should be displayed on the operation/display unit 70 at least once. In the descriptions of the embodiment, such information is called count information or main information. If at least a part of main information has not been displayed on the operation/display unit 70, more specifically if none of the main information has been displayed on the operation/display unit 70 or only a part of the main information has been displayed on the operation/display unit 70, a notice of undisplayed main information is provided.

The main information includes all information to be displayed on the operation/display unit 70 at least once. Examples of the main information include information on the currency (for example, US dollar, Chinese yuan, and Euro) counted at the recognition unit 55. The information on the number of banknotes for each denomination of the currency counted at the recognition unit 55 belongs to the main information as a narrower concept. Another example of the main information is information on denominations of banknotes (for example, one (dollar or yuan), two (dollars), and five (dollars, yuan or euros)) counted at the recognition unit 55. The information on the number of banknotes for each denomination counted at the recognition unit 55 belongs to the main information as a narrower concept. A further example is information on denominations (for example, one dollar, two dollars, five dollars, one yuan, five yuan, five euros, and 10 euros) of the currency (for example, US dollar, Chinese yuan, and Euro) counted at the recognition unit 55. The information on the number of banknotes for each denomination of the currency counted at the recognition unit 55 belongs to the main information as a narrower concept.

If the information on the currency counted at the recognition unit 55 is the main information, and if only a part of the information on the currency counted at the recognition unit 55 is displayed on the operation/display unit 70 but all the information is not displayed on the operation/display unit 70, or none of the information on the currency counted at the recognition unit 55 is displayed on the operation/display unit 70, a notice of undisplayed information is provided. If the information on denominations of banknotes counted at the recognition unit 55 is the main information, and if only a part of the information on the denominations of the banknotes counted at the recognition unit 55 is displayed on the operation/display unit 70 but all of the information is not displayed on the operation/display unit 70, or none of the information on the denominations of the banknotes counted at the recognition unit 55 is displayed on the operation/display unit 70, a notice of undisplayed information is provided.

If the main information relates to the information on the number of banknotes for each denomination of the currency counted at the recognition unit 55, and if banknotes in a certain denomination of a currency is recognized and counted at the recognition unit 55, the number of banknotes for this denomination of this currency is the main information. For example, if a mixture of US dollar banknotes and Chinese yuan banknotes is placed on the reception unit 11, and one-dollar banknotes, five-dollar banknotes (new-version notes), 10-dollar banknotes (new-version note) and 20-dollar banknotes for US dollar, and one-yuan banknotes, five-yuan banknotes (new-version notes), 10-yuan banknote (new-version notes), 20-yuan banknotes and 50-yuan banknotes for Chinese yuan, are recognized and counted by the recognition unit 55, information on the number of one-dollar banknotes, the number of five-dollar banknotes (new-version notes), the number of 10-dollar banknotes (new-version note), and the number of 20-dollar banknotes for US dollar, and the number of one-yuan banknotes, the number of five-yuan banknotes (new-version notes), the number of 10-yuan banknotes (new-version notes), the number of 20-yuan banknotes, and the number of 50-yuan banknotes for Chinese yuan is the main information (see FIGS. 4(a) and 4(b)).

As the first aspect of the notice that is provided when none of the main information, or only a part of the main information, has been displayed on the operation/display unit 70, the guidance information displayed on the operation/display unit 70 is provided. The guidance information helps an operator display the undisplayed main information on the operation/display unit 70. The guidance information may include, for example, a mark, an arrow, and a highlighted mark and a highlighted arrow. In other words, the “display of guidance information” includes newly displaying a mark or arrow, and highlighting an already displayed mark or arrow.

FIG. 4(a) shows that the number of banknotes for each denomination has been displayed on the operation/display unit 70 for all of the US dollar banknotes recognized and counted at the recognition unit 55, but no information on the number of banknotes for each denomination is displayed on the operation/display unit 70 for Chinese yuan banknotes recognized and counted at the recognition unit 55. More specifically, FIG. 4(a) shows that a star appears on the button 71b for displaying information on Chinese yuan to indicate that none of the information on the number of Chinese yuan banknotes for each denomination is displayed on the operation/display unit 70. This star is the guidance information. The star disappears as shown in FIG. 4(b) if the button 71b for displaying information on Chinese yuan is selected, and if the display on the window 79 showing count information for each denomination is scrolled down by the means of the downward arrow 72b to display, on the operation/display unit 70, all of the number of Chinese yuan banknotes for respective denominations recognized and counted by the recognition unit 55. In each of FIGS. 4(a) and 4(b), the upward arrow 72a is drawn with a dotted line. This means that the contents in the window 79 showing count information for each denomination cannot be scrolled up any more. FIG. 4(a) indicates that there is no banknote for a denomination less than one dollar. FIG. 4(b) indicates that there is no banknote for a denomination less than one yuan. On the other hand, in each of FIGS. 4(a) and 4(b), the downward arrow 72b is drawn with a solid line. This means that the contents in the window 79 showing count information for each denomination can be scrolled down. FIG. 4(a) indicates that there is one or more banknotes for a denomination greater than 20 dollars, and FIG. 4(b) indicates that there is one or more banknotes for a denomination greater than 50 yuan.

The upward arrow 72a and the downward arrow 72b are included in the guidance information.

In FIGS. 4(a) and 4(b), no star appears on the button 71c for displaying information on Euro. This means that all the information on the number of banknotes for each denomination of the Euro banknotes recognized and counted by the recognition unit 55 has already been displayed on the operation/display unit 70, or no Euro banknote is included in the banknotes recognized and counted by the recognition unit 55. Thus, with respect to Euro banknotes, there is no main information (the number of banknotes for each denomination) that has not been displayed.

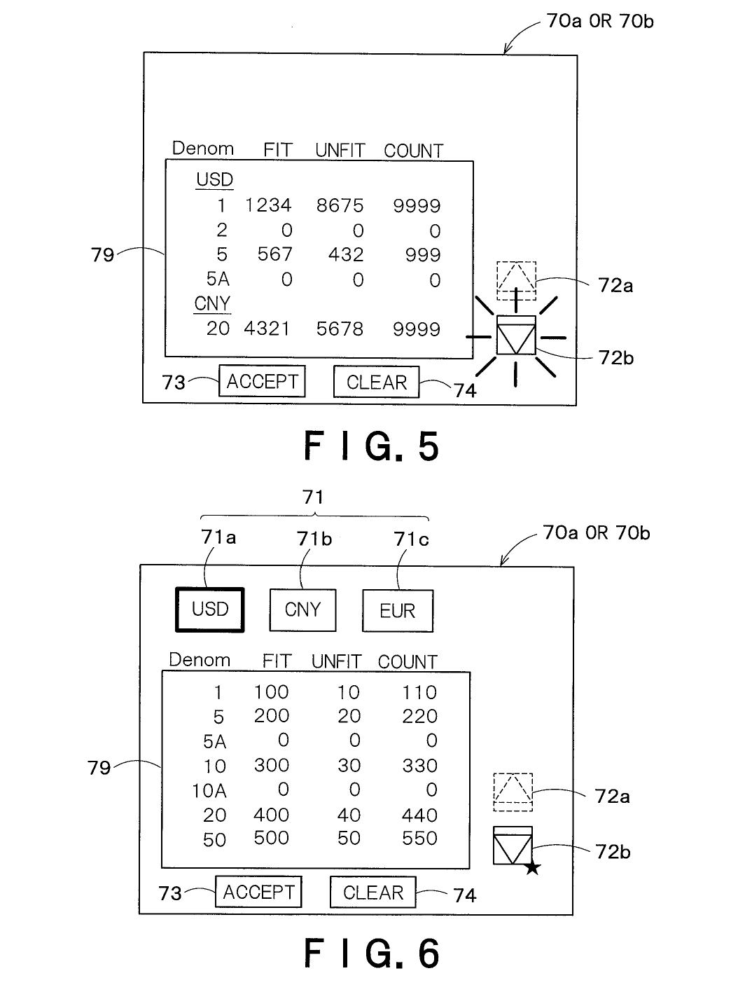

FIG. 5 shows that no button 71 is displayed for switching between currencies, and that the number of banknotes for each denomination of each currency recognized and counted by the recognition unit 55 can be confirmed by scrolling the screen. FIG. 5 also shows that although the number of US dollar banknotes for each denomination recognized and counted by the recognition unit 55 is displayed on the operation/display unit 70, the number of Chinese yuan banknotes for one or more denominations recognized and counted by the recognition unit 55 are not displayed on the operation/display unit 70. It is unclear in FIG. 5 whether there is information on the number of Euro banknotes for each denomination recognized and counted by the recognition unit 55. In FIG. 5, the downward arrow 72b, which has been displayed, is blinking and highlighted. When all of the information on the number of Chinese yuan banknotes for each denomination recognized and counted by the recognition unit 55 (if present, all of the information on the number of Euro banknotes for each denomination recognized and counted by the recognition unit 55, too) is displayed on the operation/display unit 70, the highlighting of the downward arrow 72b ends, and the downward arrow 72b is displayed in a normal state.

FIG. 6 shows that all of the information on the number of US dollar banknotes for each denomination recognized and counted by the recognition unit 55 has not been displayed on the operation/display unit 70. In FIG. 6, a star appears on the downward arrow 72b, which indicates that information on the number of US dollar banknotes for one or more denominations that are greater than 50 dollars has not been displayed on the operation/display unit 70. When all of the information on the number of US dollar banknotes for each denomination recognized and counted by the recognition unit 55 is displayed on the operation/display unit 70, the star disappears.

As the second aspect of the notice that is provided when none of the main information, or only a part of the main information, has been displayed on the operation/display unit 70, the character information 75 displayed on the operation/display unit 70 is provided. More specifically, the character information 75 indicates that there is information on the number of banknotes for each denomination recognized and counted by the recognition unit 55, which information has not been displayed on the operation/display unit 70.

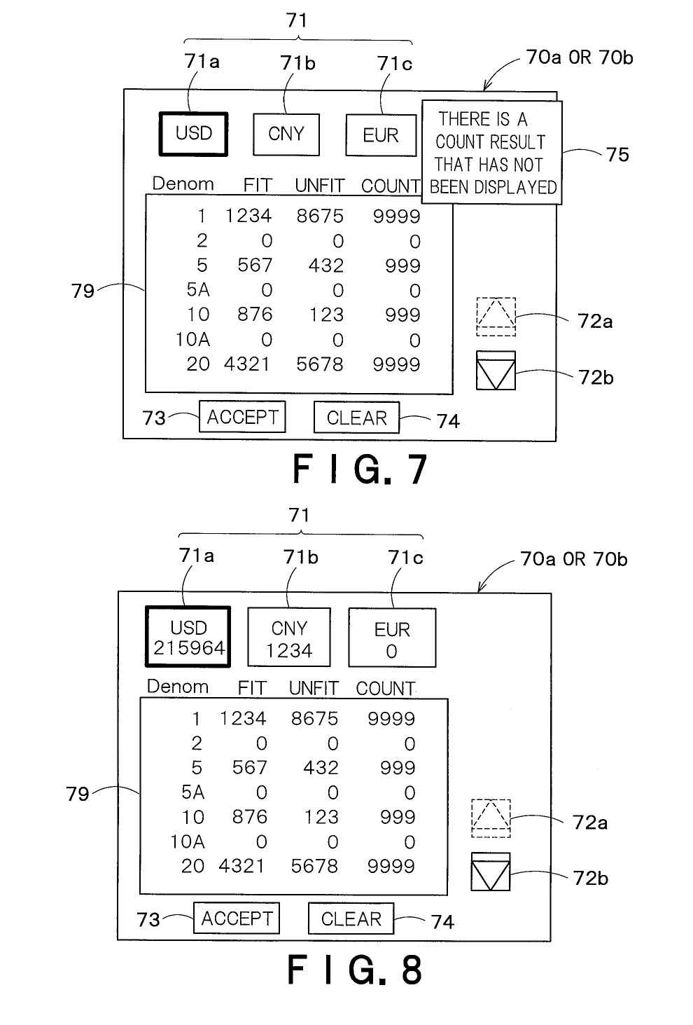

FIG. 7 shows that the character information “There is a count result that has not been displayed!” is displayed as a character string beside the buttons 71 for switching between the displays of currencies. This indicates that information on the number of Chinese yuan banknotes for each denomination, the number of Euro banknotes for each denomination, and/or the number of US dollar banknotes for one or more denominations that are greater than 20 dollars (50-dollar banknotes and/or 100-dollar banknotes) recognized and counted by the recognition unit 55 has not been displayed on the operation/display unit 70. The character information “There is a count result that has not been displayed!” as a character string disappears when all of the information on the number of Chinese yuan banknotes for each denomination, the number of Euro banknotes for each denomination, and/or the number of US dollar banknotes for one or more denominations that are greater than 20 dollars (50-dollar banknotes and/or 100-dollar banknotes) recognized and counted by the recognition unit 55 is displayed on the operation/display unit 70. The character information 75 may indicate what has not been displayed, like “There is a currency that has not been displayed!” or “There is a denomination that has not been displayed!” The character information 75 may indicate a specific type of currency or denomination that has not been displayed, like “Information on the number of 100 Chinese-yuan banknotes has not been displayed!”.

The amount of information that needs to be displayed, or the amount of information that has not been displayed may be included in the character information 75. Specifically, if the count result is displayed in several pages, the number of pages that need to be displayed, or the number of pages that have not been displayed may be displayed. Alternatively, the page number of the page now displayed may be displayed.

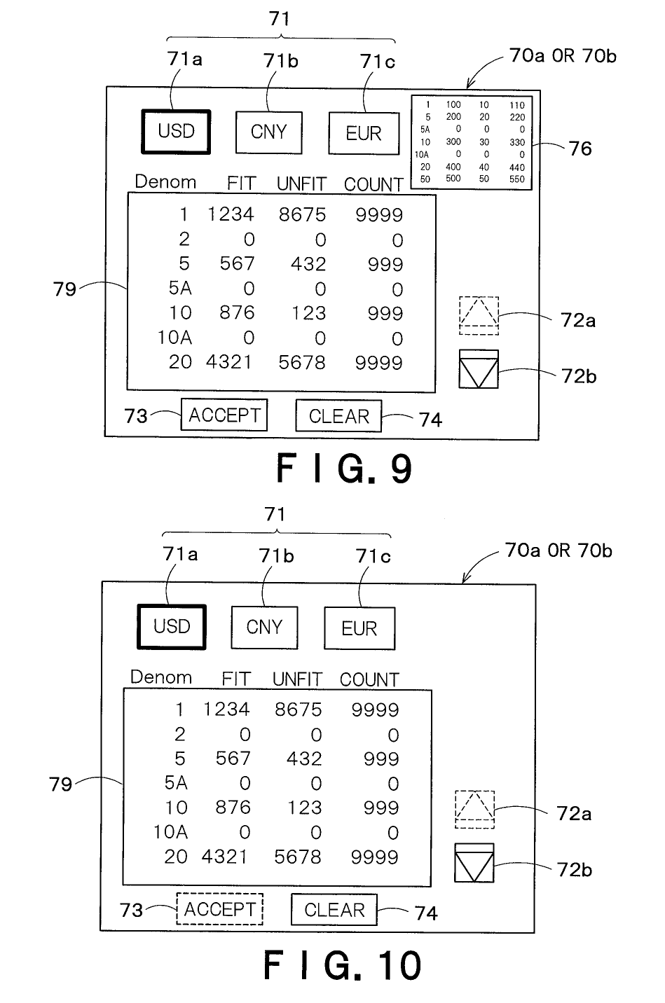

The aforementioned count information is generated based on the result of counting the number of banknotes (valuable media) at the recognition unit 55, and may include auxiliary information. The contents of auxiliary information are different from those of the main information, or may be displayed on the operation/display unit 70 in a different manner from the main information. The auxiliary information that includes contents different from those of the main information is, for example, the information obtained by simplifying the information created based on the result of counting the number of the banknotes (valuable media) at the recognition unit 55. Specifically, the auxiliary information may simply include the total amount of each currency, or the total number of banknotes for each currency (see FIG. 8). The auxiliary information that is displayed on the operation/display unit 70 in a different manner from the main information is, for another example, the information 76 that is a reduced display of information on the number of banknotes for each denomination of the currency generated based on the result of courting the number of banknotes (valuable media) at the recognition unit 55 (see FIG. 9). The reduced display may show, for example, only the number of banknotes for each denomination of a single currency.

As the third aspect of a notice that is provided when none of the main information, or only a part of the main information, has been displayed on the operation/display unit 70, the count information including auxiliary information may be provided. The notice of third aspect is performed by displaying the auxiliary information. More specifically, if there is information on the number of banknotes for each denomination of a currency recognized and counted by the recognition unit 55, and the information has not been displayed on the operation/display unit 70, the auxiliary information on the currency or the denomination may be displayed on the operation/display unit 70.

In FIG. 8, each of the buttons 71 for switching between the displays of currencies shows auxiliary information indicating the total amount of the corresponding currency recognized and counted by the recognition unit 55. More specifically, the operation/display unit 70 shows that US dollar banknotes amounting to 215,964 dollars, Chinese yuan banknotes amounting to 1,234 yuan, and no Euro banknote are recognized and counted by the recognition unit 55. This means that all of the information on the number of US dollar banknotes for each denomination recognized and counted by the recognition unit 55 has not been displayed, and all of the information on the number of Chinese yuan banknotes for each denomination recognized and counted by the recognition unit 55 has not been displayed, either. If all of the information on the number of US dollar banknotes for each denomination recognized and counted by the recognition unit 55 has been displayed on the operation/display unit 70, the number “215964” on the button 71a for displaying information on US dollar disappears. If the button 71b for displaying information on Chinese yuan is pressed down to display the information on the number of Chinese yuan banknotes for each denomination on the operation/display unit 70, and then all of the information on the number of Chinese yuan banknotes for each denomination recognized and counted by the recognition unit 55 is displayed on the operation/display unit 70, the number “1234” on the button 71b disappears. FIG. 8 shows that no Euro banknote is recognized and counted by the recognition unit 55 by the number “0” on the button 71c for displaying information on Euro banknotes. The sign indicating that there is no banknote recognized and counted by the recognition unit 55 for a certain currency is not limited to “0,” but may be the absence of any number on the buttons 71 for switching between the displays of currencies.

The fourth aspect of the notice that is provided when none of the main information, or only a part of the main information, has been displayed on the operation/display unit 70 is a refusal of the entry of an input relating to acceptance of a transaction from the operation/display unit 70 (input unit). More specifically, if there is information on the number of banknotes for some denominations of a currency recognized and counted by the recognition unit 55, which has not been displayed on the operation/display unit 70, an input relating to the acceptance of the transaction from the operation/display unit 70 may not be accepted.

The following is the example of the fourth aspect. In case that the information on counting of the number of banknotes for some denominations of a currency recognized and counted by the recognition unit 55, has not been displayed on the operation/display unit 70, the screen may not change, and a message is displayed on the operation/display unit 70 to notify that there is the information undisplayed on the operation/display unit even if the “ACCEPT” buton 73 displayed on the operation/display unit 70 is pressed down. Other examples include a case where, when there is information on the counts of banknotes for some denomination of a currency recognized and counted by the recognition unit 55, which information has not been displayed on the operation/display unit 70, the “ACCEPT” button 73 is not displayed on the operation/display unit 70 (see FIG. 10), or grayed (or displayed with a thin color) on the operation/display unit 70. FIG. 10 shows that the “ACCEPT” button 73 is indicated by a dotted line. This means that the “ACCEPT” button 73 is not displayed.

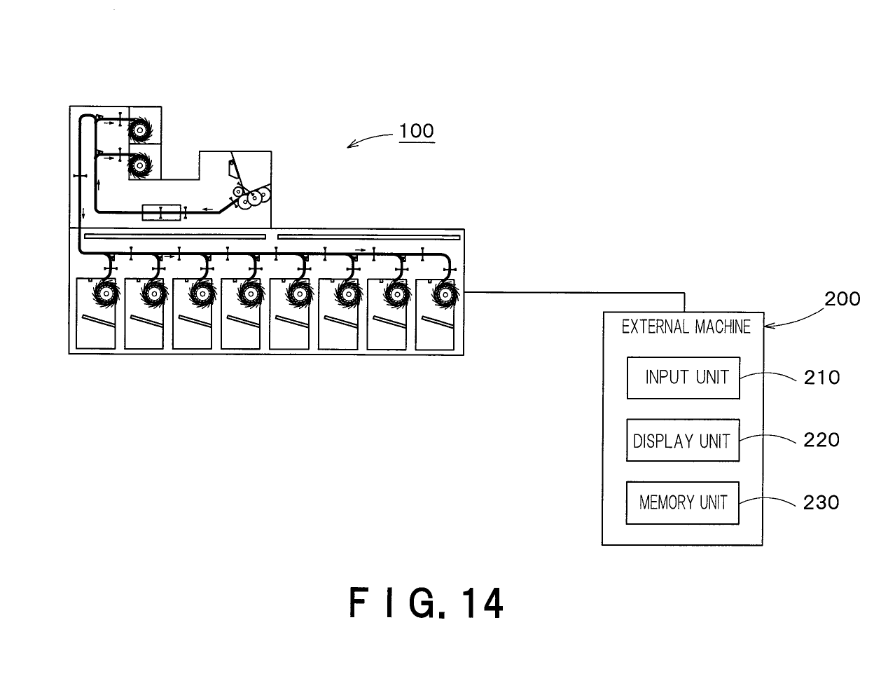

If the fourth aspect is employed, the paper sheet handling machine 100 may further include a switching unit 80 (see FIG. 3) for switching between the first mode in which, when none of the main information, or only a part of the main information, has been displayed on the operation/display unit 70, no input from the operation/display unit 70 relating to acceptance of a transaction is accepted, and the second mode in which an input from the operation/display unit 70 relating to acceptance of a transaction is accepted even if none of the main information, or only a part of the main information, is displayed on the operation/display unit 70. As shown in FIG. 3, the switching unit 80 is connected to the control unit 50 to inform the control unit 50 whether the first mode or the second mode is selected. The switching unit 80 is not necessarily included in the paper sheet handling machine 100, but may be included in an external machine 200 (see FIG. 14) that will be described later.

In the first mode, if none of the main information, or only a part of the main information, has been displayed on the operation/display unit 70, acceptance of a transaction inputted from the operation/display unit 70 is not accepted, as described above in the descriptions of the fourth aspect. In the second mode, acceptance of a transaction inputted from the operation/display unit 70 may be accepted even if none of the main information, or only a part of the main information, is displayed on the operation/display unit 70. The operation in the case where acceptance of a transaction inputted from the operation/display unit 70 is accepted even if none of the main information, or only a part of the main information, has been displayed on the operation/display unit 70 will be described later.

Two or more of the first aspect, the second aspect, the third aspect, and the fourth aspect may be arbitrarily combined. Therefore, the first aspect and the second aspect may be combined, the first aspect and the third aspect may be combined, the first aspect and the fourth aspect may be combined, the second aspect and the third aspect may be combined, the second aspect and the fourth aspect may be combined, and the third aspect and the fourth aspect may be combined. Furthermore, the first aspect, the second aspect, and the third aspect may be combined, the first aspect, the second aspect, and the fourth aspect may be combined, the first aspect, the third aspect, and the fourth aspect may be combined, and the second aspect, the third aspect, and the fourth aspect may be combined. Furthermore, all of the first aspect, the second aspect, the third aspect, and the fourth aspect may be combined.

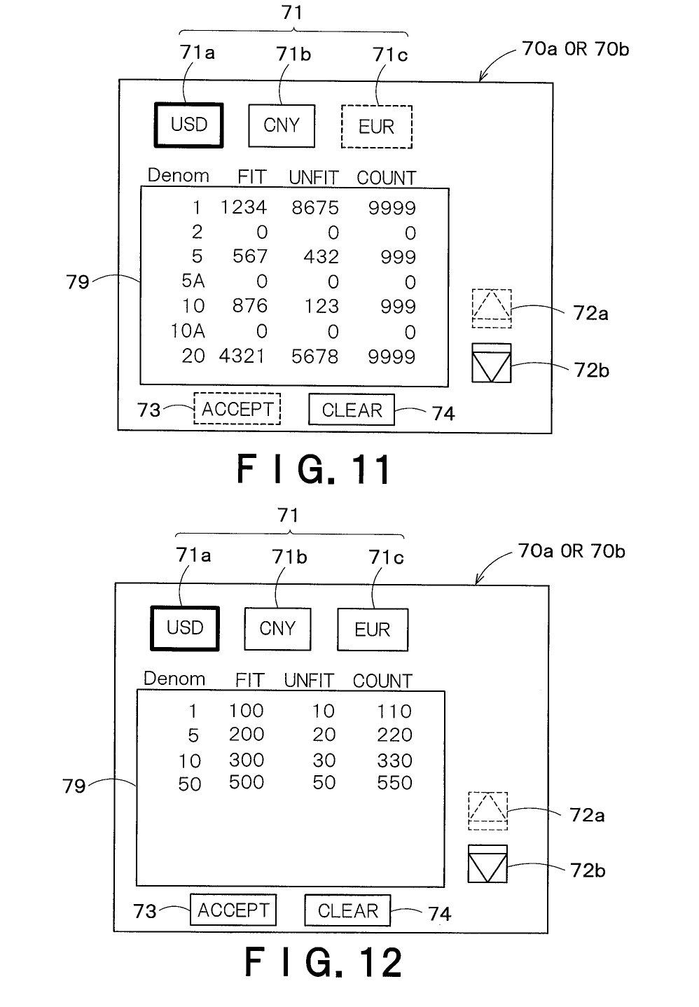

The operation/display unit 70 may display information on all of the currencies that can be handled by the paper sheet handling machine 100 regardless of whether they are counted by the recognition unit 55. For example, the buttons 71 (in FIGS. 4 and 6 to 9, the button 71a for displaying information on US dollar, the button 71b for displaying information on Chinese yuan, and the button 71c for displaying information on Euro) for switching between the displays of currencies handled by the paper sheet handling machine 100 may be displayed regardless of whether the currencies are counted by the recognition unit 55. The display on the operation/display unit 70 is not limited to this, and only information relating to the currencies that are counted by the recognition unit 55 may be displayed on the operation/display unit 70, and the information on the currencies that are not counted by the recognition unit 55 may not be displayed on the operation/display unit 70. For example, if only US dollar banknotes and Chinese yuan banknotes are recognized by the recognition unit 55, only the button 71a for displaying information on US dollar and the button 71b for displaying information on Chinese yuan may be displayed on the operation/display unit 70, and the button 71c for displaying information on Euro may not be displayed on the operation/display unit 70, as shown in FIG. 11 (in FIG. 11, the button 71c for displaying information on Euro is drawn by a dotted line, which means that the button 71c is not displayed on the operation/display unit 70). FIG. 11 shows the fourth aspect, in which, if there is information on the number of banknotes for some denominations of a currency recognized and counted by the recognition unit 55, which information has not been displayed on the operation/display unit 70, the “ACCEPT” button 73 is not displayed on the operation/display unit 70.

The operation/display unit 70 may display all of the information on the banknotes for each denomination regardless of whether the banknotes are counted by the recognition unit 55. Thus, the number of banknotes for all of the denominations may be displayed regardless of whether they are all counted by the recognition unit 55 (see FIGS. 4 to 11). However, the display on the operation/display unit 70 is not limited, and only the information on the banknotes for some denominations counted by the recognition unit 55 may be displayed on the operation/display unit 70, and the information on the banknotes for some denominations not counted by the recognition unit 55 may not be displayed on the operation/display unit 70. For example, if only one-dollar banknotes, five-dollar banknotes (new-version notes), 10-dollar banknotes (new-version notes), and 50-dollar banknotes of US dollar banknotes are counted by the recognition unit 55, only the number of one-dollar banknotes, the number of five-dollar banknotes (new-version note), the number of 10-dollar banknotes (new-version notes), and the number of 50-dollar banknotes are displayed on the operation/display unit 70 as shown in FIG. 12.

If none of the main information, or only a part of the main information, has been displayed on the operation/display unit 70, the notice is not necessarily provided from the beginning (immediately after the counting operation is finished). For example, a notice may be provided when there is an input from the operation/display unit 70 with respect to acceptance of a transaction when none of the main information, or only a part of the main information, has been displayed on the operation/display unit 70. In this case, the first input from the operation/display unit 70 with respect to the acceptance of the transaction is not accepted.

More specifically, if none of, or only a part of, the information on the number of banknotes for each denomination of a currency recognized and counted by the recognition unit 55 has been displayed on the operation/display unit 70, and an operator presses down the “ACCEPT” button 73 on the operation/display unit 70 for the acceptance of the transaction, a mark or arrow may appear, or an already displayed mark or arrow may be highlighted on the operation/display unit 70 to serve as guidance information described in the descriptions of the first aspect, so as to allow information on the number of banknotes for each denomination of the currency recognized and counted by the recognition unit 55 to be displayed (see FIGS. 4 to 6).

If none of, or only a part of, the information on the banknotes for each denomination of the currency recognized and counted by the recognition unit 55 has been displayed on the operation/display unit 70, and an operator presses down the “ACCEPT” button 73 of the operation/display unit 70 to accept the transaction, character information 75, which is a notice of undisplayed information, may be displayed on the operation/display unit 70 as in the case of the second aspect (see FIG. 7).

If none of, or only a part of, the information on the number of banknotes for each denomination of a currency recognized and counted by the recognition unit 55 has been displayed on the operation/display unit 70, and an operator presses down the “ACCEPT” button 73 of the operation/display unit 70 to accept the transaction, auxiliary information may be displayed on the operation/display unit 70 as the third aspect (see FIGS. 8 and 9).

In the paper sheet handling machine 100 according to the embodiment, at the same time or after a notice of undisplayed main information is displayed on the operation/display unit 70, a question as to whether the transaction may be accepted may be given to the operator. There may be various ways of giving the question. An example of the way of asking is a message which displays on the operation/display unit 70 and asks whether or not the transaction may be accepted. Even if none of, or only a part of, the main information has been displayed on the operation/display unit 70, the operator presses down the “ACCEPT” button 73 on the operation/display unit 70 under this circumstance, and the transaction may be accepted despite the presence of the undisplayed main information.

As described above, the valuable medium handling system according to the embodiment may be a single valuable medium handling machine such as a paper sheet handling machine 100, or a combination of a valuable medium handling machine such as a paper sheet handling machine 100 and an external machine 200 including a display screen, a personal computer, and/or a tablet terminal connected to the valuable medium handling machine such as the paper sheet handling machine 100. If the external machine 200 is provided, the external machine 200 may occupy the paper sheet handling machine 100 to disable the operations, such as input operations, of the paper sheet handling machine 100. Hereinafter, an aspect that may be employed in the valuable medium handling system, specifically the paper sheet handling system, and more specifically the banknote handling system of the embodiment will be described.

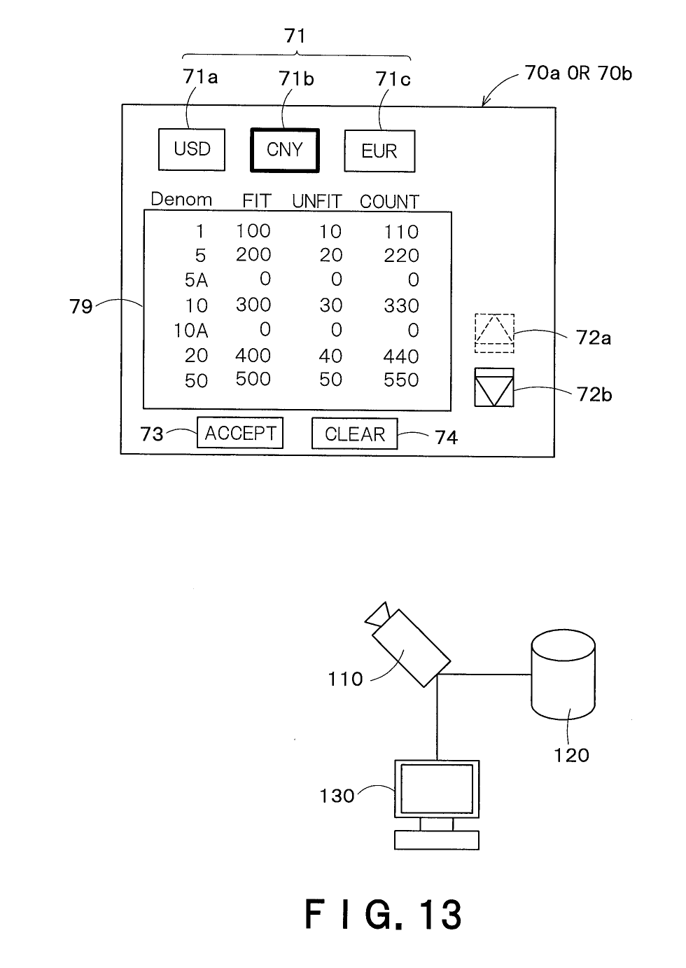

As shown in FIG. 13, the valuable medium handling system according to the embodiment includes an imaging unit 110 configured to take an image of the operation/display unit 70, and an image memory unit 120 connected to the imaging unit 110 and configured to store the image taken by the imaging unit 110. The operation/display unit 70 may display a message asking whether the transaction may be accepted and/or an enlarged button for performing the acceptance operation (for example, the “ACCEPT” button 73 described above) if none of the main information, or only a part of the main information, has been displayed. A state of the message asking whether the transaction may be accepted and/or the enlarged button for performing the acceptance operation displayed on the operation/display unit 70 is taken by the imaging unit 110 and stored in the image memory unit 120. Therefore, when a manager checks the image taken by the imaging unit 110 later, the transaction acceptance operation that is being performed or performed later without displaying the part of the main information that has not been displayed on the operation/display unit 70 may be noticed at a glance (since the button is enlarged on the display). An image display unit 130 may further be included, which is connected to the imaging unit 110 as shown in FIG. 13, so that the manager may watch the image taken by the imaging unit 110 in real time.

In addition to or instead of the above message and/or the enlargement of the button 71 for the acceptance operation displayed on the operation/display unit 70, the operation/display unit 70 may display a notice when there is undisplayed main information and transaction is accepted. The notice of the acceptance of the transaction is displayed not only in the first aspect, the second aspect and the third aspect of the embodiment, but also in the second mode of the fourth aspect, and when a transaction is accepted in the fourth aspect, as will be described later.

Thus, if there is undisplayed main information and a notice of an acceptance of a transaction is displayed on the operation/display unit 70, and if the valuable medium handling system includes the imaging unit 110 configured to take an image of the display on the operation/display unit 70 and the image memory unit 120 configured to store the image taken by the imaging unit 110, the imaging unit 110 may take an image showing that the transaction is accepted without displaying undisplayed main information on the operation/display unit 70, and the image may be stored in the image memory unit 120. The valuable medium handling system may also include the image display unit 130 connected to the imaging unit 110 so that the manager may watch the image taken by the imaging unit 110 in real time through the image display unit 130, as described above. Furthermore, if there is undisplayed main information and acceptance of a transaction is inputted, a notice may be displayed on the external machine 200 such as a personal computer or tablet terminal to worn the manager of the acceptance of the transaction despite the existence of the undisplayed main information.

The notice indicating that the transaction is accepted may be displayed in an enlarged manner. Typically, the notice may be enlarged to the entire area of the screen of the operation/display unit 70. In this case, the manager may notice, at a glance (since the notice is enlarged) that the transaction is accepted without displaying undisplayed main information on the operation/display unit 70 although none of the main information, or only a part of the main information, has been displayed on the operation/display unit 70 when the manger checks the image taken by the imaging unit 110 later, or the manager is checking the images in real time through the image display unit 130.

If none of the main information, or only a part of the main information, has been displayed, and the transaction is accepted without displaying all of the main information on the operation/display unit 70, the log is stored in the memory unit 56 of the paper sheet handling machine 100, or an external memory unit 230 (see FIG. 14) of the external machine 200 such as a personal computer or a tablet terminal connected to the paper sheet handling machine 100. The manager may be aware that the transaction was accepted without displaying all of the main information on the operation/display unit 70 although none of the main information, or only a part of the main information, has been displayed, based on the log stored in the memory unit 56 of the paper sheet handling machine 100, or the external memory unit 230 of the external machine 200. If the operator's ID needs to be inputted when paper sheets such as banknotes are handled by the paper sheet handling machine 100, it may be easily grasped which operator accepted the transaction without displaying all of the main information on the operation/display unit 70 by checking the operator's ID and the time when the transaction is accepted.

The external machine 200 may include an external display unit 220 as shown in FIG. 14, and the external display unit 220 may have the same role as the operation/display unit 70. In this case, the external display unit 220 may be used instead of the operation/display unit 70 or in addition to the operation/display unit 70. If the external display unit 220 has the same role as the operation/display unit 70, and is used instead of the operation/display unit 70, the external display unit 220 corresponds to the “display unit” recited in the claims. If the external display unit 220 is used in addition to the operation/display unit 70, each of the operation/display unit 70 and the external display unit 220 corresponds to the “display unit” recited in the claims. Examples of the external display unit 220 include a single display screen, a display screen of a personal computer, and a display screen of a tablet terminal.

The external machine 200 may include an external input unit 210 as shown in FIG. 14, and the external input unit 210 may have the same role as the operation/display unit 70. In this case, the external input unit 210 may be used instead of the operation/display unit 70 or in addition to the operation/display unit 70. If the external input unit 210 has the same role as the operation/display unit 70, and the external input unit 210 is used instead of the operation/display unit 70, the external input unit 210 corresponds to the “input unit” recited in the claims. If the external input unit 210 is used in addition to the operation/display unit 70, each of the operation/display unit 70 and the external input unit 210 corresponds to the “input unit” recited in the claims. Examples of the external input unit 210 include an input terminal of a personal computer and a display screen of a tablet terminal including a touch panel.

If each of the operation/display unit 70 and the external display unit 220 corresponds to the display unit recited in the claims, and if none of the main information (for example, the number of banknotes for each denomination of a currency recognized and counted by the recognition unit 55), or only a part of the main information has been displayed on the operation/display unit 70 and/or the external display unit 220, each of the operation/display unit 70 and the external display unit 220 may display a notice of undisplayed main information, and the notice may disappear when all of the main information is displayed on at least one of the operation/display unit 70 and the external display unit 220. If the operation/display unit 70 is independent of the external display unit 220, and none of the main information, or only a part of the main information, has not been displayed on the operation/display unit 70, the operation/display unit 70 may display a notice of undisplayed main information. If none of the main information, or only a part of the main information, has not been displayed on the external display unit 220, the external display unit 220 may display a notice of undisplayed information.

The case where none of, or only a part of, the main information has been displayed on the operation/display unit 70 and the external display unit 220, each of the operation/display unit 70 and the external display unit 220 displays a notice of undisplayed main information. The notice disappears when all of the main information is displayed on at least one of the operation/display unit 70 and the external display unit 220 (an aspect of the valuable medium handling system according to the embodiment) will be briefly described below.

If the first aspect described above is employed in the valuable medium handling system according to the embodiment, and if none of the main information (for example, the number of banknotes for each denomination of a currency recognized and counted by the recognition unit 55) has been displayed on the operation/display unit 70 and the external display unit 220, or a part of the main information has not been displayed, guidance information for displaying undisplayed main information on the operation/display unit 70 is displayed on each of the operation/display unit 70 and the external display unit 220 (see FIGS. 4 to 6). The display of the guidance information disappears when either the operation/display unit 70 or the external display unit 220 displays all of the main information.

If the second aspect described above is employed, and if none of the main information (for example, the number of banknotes for each denomination of a currency recognized and counted by the recognition unit 55) has been displayed on the operation/display unit 70 and the external display unit 220, or a part of the main information has not been displayed, character information 75 for notifying of the presence of the undisplayed main information is displayed on each of the operation/display unit 70 and the external display unit 220 (see FIG. 7). The display of the character information 75 disappears when all of the main information is displayed on either the operation/display unit 70 or the external display unit 220.

If the third aspect described above is employed, and if none of the main information (for example, the number of banknotes for each denomination of a currency recognized and counted by the recognition unit 55) has been displayed on the operation/display unit 70 and the external display unit 220, or a part of the main information has not been displayed, auxiliary information created based on the result of counting the banknotes at the recognition unit 55 is displayed on each of the operation/display unit 70 and the external display unit 220 (see FIGS. 8 and 9). The display of the auxiliary information disappears when all of the main information is displayed on either the operation/display unit 70 or the external display unit 220.

If the fourth aspect described above is employed, and if none of the main information (for example, the number of banknotes for each denomination of a currency recognized and counted by the recognition unit 55) has been displayed on the operation/display unit 70 and the external display unit 220, or a part of the main information has not been displayed, the input of acceptance of a transaction from the “ACCEPT” button 73 of the operation/display unit 70 included in the paper sheet handling machine 100 is not accepted, and an input of acceptance of the transaction from the external input unit 210 of the external machine 200 is not accepted. This indicates that none of the main information has been displayed on the operation/display unit 70 and the external display unit 220, or only a part of the main information has been displayed (see FIGS. 10 and 11). The transaction may be accepted from the operation/display unit 70 and the external input unit 210 of the external machine 200 after all of the main information is displayed on either the operation/display unit 70 or the external display unit 220.

In this aspect of the valuable medium handling system according to the embodiment, the notice is not necessarily displayed from the beginning when none of the main information has been displayed on the operation/display unit 70 and the external display unit 220, or only a part of the main information has been displayed. For example, if none of the main information has been displayed on the operation/display unit 70 and the external display unit 220, or only a part of the main information has been displayed, and acceptance of a transaction is inputted from the “ACCEPT” button 73 of the operation/display unit 70 of the paper sheet handling machine 100, a notice indicating the presence of undisplayed main information may be displayed on the operation/display unit 70. If acceptance of the transaction is inputted from the input unit of the external machine 200, a notice indicating the presence of undisplayed main information may be displayed on the external display unit 220.

If the imaging unit 110 described above is employed in the aspect of the valuable medium handling system according to the embodiment, more than one imaging unit 110 may be provided, and an image of each of the operation/display unit 70 and the external display unit 220 may be taken. In this case, both images of the contents of the display on the operation/display unit 70 and the contents of the display on the external display unit 220 may be taken by the imaging unit 110 and stored in the image memory unit 120, and both the contents of the display on the operation/display unit 70 and the contents of the display on the external display unit 220 may be checked by the manger in real time through the image display unit 130.

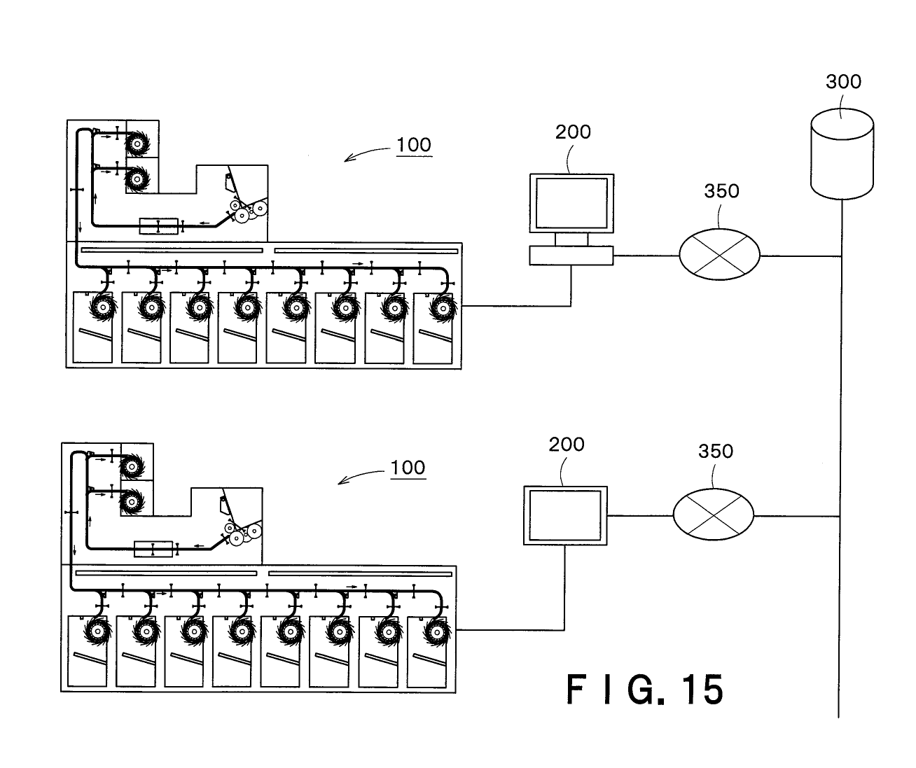

The valuable medium handling system according to the embodiment may include a plurality of paper sheet handling machines 100 (valuable medium handling machines), a plurality of external machine 200 each including a display screen, a personal computer, and/or a tablet terminal and connected to one of the paper sheet handling machines 100 (valuable medium handling machines), and a server 300 connected to the paper sheet handling machines 100 and the external machines 200 via the Internet 350, as shown in FIG. 15. FIG. 15 shows an aspect in which a plurality of paper sheet handling machines 100 are connected to a server 300 via external machines 200 and the Internet 350. The server 300 may receive information on banknotes handled by the paper sheet handling machine 100, including information on a serial number (information including characters and numbers for uniquely specifying the corresponding banknote) on each of the banknotes, from each paper sheet handling machine 100 and store the information. If this aspect is employed, the serial numbers may be unitarily managed by the server 300, and counterfeit notes, for example, may be easily retrieved.

### <<Method>>

A valuable medium handling method according to an embodiment, more specifically a banknote handling method, will be described below. The contents of the descriptions of the method overlapping those having been described in the descriptions of the configuration will be omitted if it is appropriate to do so. In the following descriptions, the operation/display unit 70 serves as the “display unit” and the “input unit.” However, as has already been described above, the external display unit 220 may be used as the “display unit” instead of the operation/display unit 70, or added to the operation/display unit 70, and the external input unit 210 may be used as the “input unit” instead of the operation/display unit 70, or added to the operation/display unit 70.

First, a plurality of banknotes in a stacked state is placed on and received by a reception unit 11 of a paper sheet handling machine 100 (see FIGS. 1 and 2). Next, a taking-in unit 10 takes in, one by one, the lowermost one of the banknotes received by the reception unit 11 into a housing 1 (see FIG. 2). The banknotes taken in into the housing 1 are transported by a transport unit 20 one by one. While the banknotes are being transported by the transport unit 20, a recognition unit 55 recognizes such features as denomination, fitness, face/back, version, orientation, and authentication of the banknotes. Each banknote is transported to a corresponding stacker 60 based on the result of the recognition by the recognition unit 55. If the denomination, for example, of a banknote is not recognized by the recognition unit 55 and thus a recognition error is caused, or if a banknote causes a transport error due to such states as skewed state, overlapped state, and chained state, the banknote is transported to a rejection unit 61 instead of a stacker 60. The “skewed state” means that the banknote is obliquely transported, the “overlapped state” means that overlapped banknotes are transported, and the “chained state” means that banknotes are transported without having a predetermined space therebetween.

Each of the banknotes received by the reception unit 11 is recognized and counted by the recognition unit 55 in this manner. When all of the banknotes received by the reception unit 11 are recognized and counted by the recognition unit 55, the recognition and counting operation for the corresponding transaction is finished.

When the recognition and counting operation for the corresponding transaction is finished, an operation/display unit 70 displays count information based on the result of the counting of the banknotes performed by the recognition unit 55. As has already been described, the count information includes main information that needs to be displayed on the operation/display unit 70 at least once. Examples of the main information include information on the currency (for example, US dollar, Chinese yuan, and Euro) counted by the recognition unit 55, information on denominations (for example, one (dollar or yuan), two (dollars), five (dollars, yuan, or euros) of the banknotes counted by the recognition unit 55, and information on denominations (for example, one dollar, two dollars, five dollars, one yuan, five yuan, five euros, and 10 euros) of the currency (for example, US dollar, Chinese yuan, and Euro) counted by the recognition unit 55. Typically, the main information is the number of banknotes for each denomination (for example, one dollar, two dollars, five dollars, one yuan, five yuan, five euros, and 10 euros) of the currency (for example, US dollar, Chinese yuan, and Euro) counted by the recognition unit 55 (the count of banknotes for each denomination).

With respect to the display on the operation/display unit 70, information on all the currencies and all the denominations of banknotes may be displayed on the operation/display unit 70 regardless of whether the banknotes are counted by the recognition unit 55 (see FIGS. 4 to 10). Alternatively, only information on the currency counted by the recognition unit 55 may be displayed on the operation/display unit 70, but information on the currency not counted by the recognition unit 55 may not be displayed on the operation/display unit 70 (see FIG. 11), or only information on denominations of the banknotes counted by the recognition unit 55 may be displayed on the operation/display unit 70, but information on denominations of the banknotes not counted by the recognition unit 55 may not be displayed on the operation/display unit 70 (see FIG. 12).

If the first aspect of the display of notice is employed when none of the main information has been displayed on the operation/display unit 70, or only a part of the main information has been displayed, guidance information (a newly displayed mark or arrow, or a highlighted display of a mark or arrow) is displayed on the operation/display unit 70 for displaying undisplayed main information on the operation/display unit 70 (see FIGS. 4 to 6). If the second aspect of the display of notice is employed when none of the main information has been displayed on the operation/display unit 70, or only a part of the main information has been displayed, character information 75 indicating the presence of undisplayed main information is displayed on the operation/display unit 70 (see FIG. 7). If the third aspect of the display of notice is employed when none of the main information has been displayed on the operation/display unit 70, or only a part of the main information has been displayed, auxiliary information indicating the presence of undisplayed main information is displayed on the operation/display unit 70 (see FIGS. 8 and 9). If the fourth aspect of the display of notice is employed when none of the main information has been displayed on the operation/display unit 70, or only a part of the main information has been displayed, acceptance of a transaction inputted from the operation/display unit 70 is rejected, and thus the operator cannot make the transaction be accepted through the operation/display unit 70. This indicates that there is undisplayed main information (see FIGS. 10 and 11).

If all of the main information is displayed on the operation/display unit 70, the guidance information disappears from the display of the operation/display unit 70 when the first aspect is employed, the character information 75 disappears from the display of the operation/display unit 70 when the second aspect is employed, or the auxiliary information disappears from the display of the operation/display unit 70 when the third aspect is employed. If the fourth aspect is employed, the acceptance operation inputted from the operation/display unit 70 is accepted when all of the main information is displayed on the operation/display unit 70. In this case, the “ACCEPT” button 73 (see FIGS. 10 and 11), which has not been displayed, may appear on the operation/display unit 70 to indicate that the acceptance operation inputted from operation/display unit 70 may now be accepted, or the “ACCEPT” button 73, which has been grayed (or displayed in a thin color) may now be displayed in a normal state. Alternatively, characters, marks, etc., may be displayed on the operation/display unit 70 to indicate that the acceptance operation inputted from the operation/display unit 70 may now be accepted.

The notice indicating that none of the main information has been displayed on the operation/display unit 70 or only a part of the main information has been displayed may be displayed on the operation/display unit 70 at the time when the recognition and counting operation with respect to the target transaction is finished. Alternatively, the notice indicating that none of the main information has been displayed on the operation/display unit 70 or only a part of the main information has been displayed may be displayed only when acceptance of the transaction is inputted from the operation/display unit 70. In the latter case, when the operator tries to accept the transaction through the operation/display unit 70, more specifically by pressing down the “ACCEPT” button 73 once, the acceptance of the transaction is rejected, and guidance information according to the first aspect, the character information 75 according to the second aspect, or the auxiliary information according to the third aspect is displayed on the operation/display unit 70.

If the fourth aspect is employed, the input for acceptance of the transaction may “never” be accepted if none of the main information has been displayed on the operation/display unit 70, or only a part of the main information has been displayed. Alternatively, the input for acceptance of the transaction may be rejected at least once, and after a predetermined process, for example after a question is displayed on the operation/display unit 70 as to whether the transaction may be accepted without checking all of the main information, the transaction may be accepted.

An aspect in which an input for acceptance of a transaction may be rejected at least once and accepted after a predetermined process is performed will be considered. In this aspect, a case where a notice indicating that none of the main information has been displayed on the operation/display unit 70 or only a part of the main information has been displayed is displayed not from the beginning (immediately after the counting operation with respect to the target transaction is finished) but only after acceptance of the target transaction is inputted from the operation/display unit 70 will be briefly described below. In this case, if acceptance of the transaction is inputted from the operation/display unit 70 although none of the main information has been displayed on the operation/display unit 70 or only a part of the main information is displayed, the input for acceptance of the transaction is rejected, and guidance information according to the first aspect, character information 75 according to the second aspect, and/or auxiliary information according to the third aspect, or a question as to whether the input for acceptance of the transaction may be accepted without checking all of the main information are/is displayed on the operation/display unit 70. The transaction is accepted only when acceptance of the transaction is inputted from the operation/display unit 70 again while the guidance information, the character information 75, and/or the auxiliary information, or the question as to whether the transaction may be accepted without checking all of the main information are/is displayed on the operation/display unit 70.

Even if the fourth aspect is employed, if the fourth aspect has the first mode in which acceptance of a transaction inputted from the operation/display unit 70 is rejected when none of the main information has been displayed on the operation/display unit 70, or only a part of the main information has been displayed, and the second mode in which acceptance of a transaction inputted from the operation/display unit 70 is accepted even if none of the main information has been displayed on the operation/display unit 70, or only a part of the main information has been displayed, the first mode and the second mode being switchable, the transaction may be accepted if the second mode is selected while a notice is displayed on the operation/display unit 70 indicating that none of the main information has been displayed on the operation/display unit 70 or only a part of the main information has been displayed.

If the aspect is employed, in which an input for acceptance of a transaction is accepted even if none of the main information has been displayed on the operation/display unit 70 or only a part of the main information is displayed, a question as to whether the transaction may be accepted without checking all of the main information, or a button (for example, the “ACCEPT” button 73 described above) for inputting the acceptance may be displayed on the operation/display unit 70 in an enlarged state. Alternatively, a message indicating that the transaction is accepted although there is undisplayed main information may be displayed on the operation/display unit 70 (in an enlarged manner). The image on the operation/display unit 70 may be taken by the imaging unit 110 and stored in the image memory unit 120, or watched by the manager in real time through the image display unit 130.

As described above, the handling of the target transaction is finished when the acceptance of the transaction inputted from the operation/display unit 70 is accepted after all of the main information is displayed on the operation/display unit 70, or accepted even if none of the main information has been displayed on the operation/display unit 70 or only a part of the main information is displayed on the operation/display unit 70. After the handling of the transaction is finished, the operator takes out the banknotes stored in the stackers 60 from the front portions of the stackers 60. Then, the same procedure of handling is performed on the next group of banknotes.

A further aspect of the embodiment will be described below.

In this aspect, the contents of the display on the operation/display unit 70 differ between a case where the count information relates only to a single currency, and a case where the count information relates to at least two currencies. In more detail, if the count information relates only to a single currency, the operation/display unit 70 displays main information of the currency. An example of the main information is the number of banknotes for each denomination of the currency. If the count information relates to two or more currencies, the operation/display unit 70 may display auxiliary information of each currency, or both the auxiliary information and the main information of each currency. An example of the auxiliary information is the number of banknotes and the total amount of each currency. In this aspect, the operation/display unit 70 may first display the main information on the currency counted by the recognition unit 55 at the beginning of a transaction, and then display auxiliary information for each currency when the recognition unit 55 counts banknotes of a currency that is different from the currency counted at the beginning of the transaction. When the auxiliary information is displayed on the operation/display unit 70, one of the currencies displayed on the operation/display unit 70 may be selected to display the main information of the currency (for example the number of banknotes for each denomination of the currency).

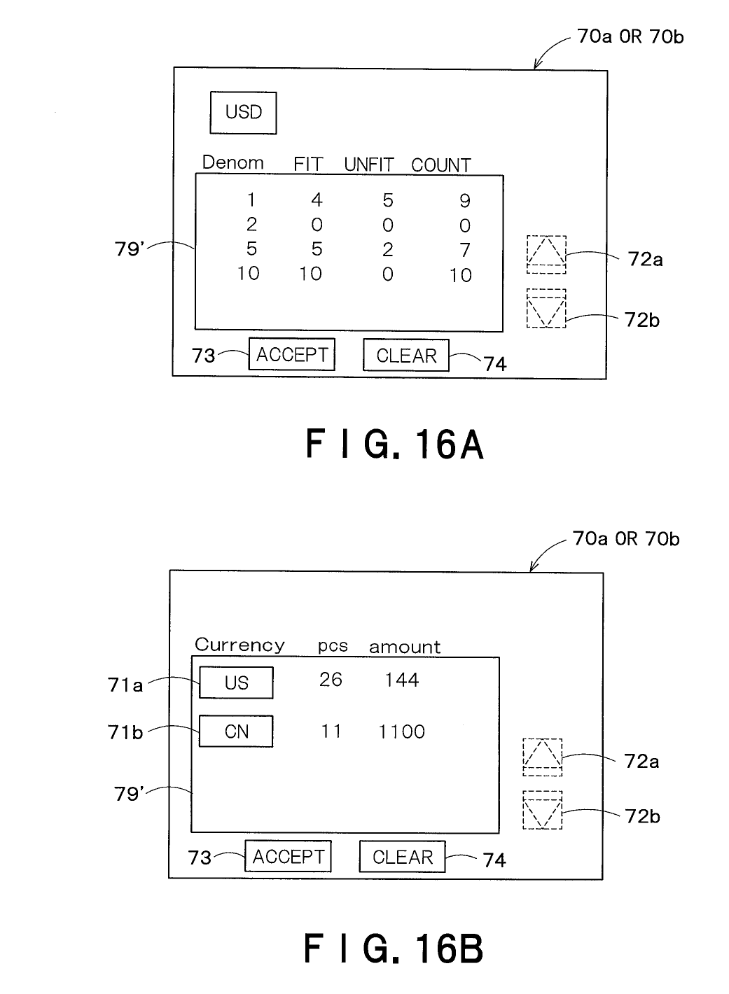

FIGS. 16(a) and 16(b) show specific examples of the display. The operation/display unit 70 (operation display screen 70a or 70b) shown in each of FIGS. 16(a) and 16(b) includes the window 79′ showing information on the number of banknotes instead of the window 79 showing count information for each denomination described above.

For example, if a US dollar (USD) banknote is first counted by the recognition unit 55 in a transaction, and then 26 US dollar banknotes including eight one-dollar banknotes, seven five-dollar banknotes, and 10 10-dollar banknotes are counted by the recognition unit 55, the display of the number information display window 79′ is as shown in FIG. 16(a). If the 27-th banknote is a Chinese yuan (CNY) banknote, the window 79′ displays auxiliary information, which is the number of banknotes and the total amount of the banknotes for each of US dollar (USD) and Chinese yuan (CNY) as shown in FIG. 16(b). FIG. 16(b) shows that the 27-th to the last (more specifically the 37-th) banknotes are Chinese yuan (CNY) banknotes. More specifically, the 27-th to the last (more specifically the 37th) banknotes are 100-yuan banknotes.

In the display of the number information display window 79′ as shown in FIG. 16(b), information on the number of US dollar (USD) banknotes for each denomination is displayed in the number information display window 79′ if a button 71a for displaying information on US dollar (USD) is pressed down (see FIG. 16(a)), and information on the number of Chinese yuan (CNY) banknotes for each denomination is displayed on the window 79′ by pressing down a button 71b for displaying information on Chinese yuan (CNY).

### <<Effect>>

Next, effects obtained from the embodiment having the configuration described above, which have not been described yet or which are especially important, will be described below.

In the embodiment, a notice is displayed if at least a part of the main information that needs be displayed on the operation/display unit 70 and/or the external display unit 220 at least once has not been displayed on the operation/display unit 70 and/or the external display unit 220. Therefore, the operator may become aware that the main information that needs be visually confirmed has not been displayed. Thus, according to the embodiment, it may be prevented that the operator performs an operation for accepting a transaction and proceeds to the next transaction without being aware of the presence of main information that has not been displayed on the operation/display unit 70 and/or the external display unit 220.

This point will be described below. If banknotes of two or more currencies are mixed and recognized by the paper sheet handling machine while the operator is not aware of the mixed state in the invention disclosed in WO 2009/069197, the operator may proceed to the next step by performing an operation for accepting the transaction without visually checking the information on the currency (for example, the number of banknotes for each denomination of the currency). If only a single currency with various denominations is handled, it may not be possible to display all of the counts of banknotes for respective denominations on the display unit. Also in this case, the operator may proceed to the next step by performing a transaction acceptance operation without visually checking the information on undisplayed denominations (for example, information on the number of banknotes for each denomination). The embodiment solves this problem. According to the embodiment, if at least a part of the main information has not been displayed on the operation/display unit 70 and/or the external display unit 220, a notice is displayed. Therefore, the operator may be aware of the presence of undisplayed main information. This may prevent the operator from performing a transaction acceptance operation without being aware of the presence of undisplayed main information as in conventional cases.

If the first aspect described above is employed, in which, if none of the main information has been displayed on the operation/display unit 70 and/or the external display unit 220 or only a part of the main information has been displayed, guidance information for displaying the undisplayed main information on the operation/display unit 70 and/or the external display unit 220 is displayed on the operation/display unit 70 and/or the external display unit 220 (see FIGS. 4 to 6). Therefore, the operator may understand at a glance which operation needs to be performed to display the main information that should be visually checked. This improves the efficiency in checking the main information.

If the second aspect described above is employed, in which, if none of the main information has been displayed on the operation/display unit 70 and/or the external display unit 220 or only a part of the main information has been displayed, character information 75 for notifying of the undisplayed information is displayed on the operation/display unit 70 and/or the external display unit 220 (see FIG. 7), the operator may understand at a glance what needs to be done, more specifically there is main information that has not been displayed on the operation/display unit 70 and/or the external display unit 220. This helps the operator (especially inexperienced operator) to improve the efficiency of the checking work. In a case where the character information notifies of the presence of undisplayed currency, or the presence of undisplayed denominations, the operator may be clearly aware of what needs to be checked. In more detail, if which denomination of the currency has not been displayed is specified, the operator may be more clearly aware of what needs to be checked. This is very advantageous.

If the third aspect described above is employed, in which, if none of the main information has been displayed on the operation/display unit 70 and/or the external display unit 220 or only a part of the main information has been displayed, auxiliary information is displayed on the operation/display unit 70 and/or the external display unit 220 to notify that none of the main information has been displayed on the operation/display unit 70 and/or the external display unit 220, or only a part of the main information has been displayed (see FIGS. 8 and 9), the operator, after obtaining the auxiliary information, may confirm the undisplayed main information on the operation/display unit 70 and/or the external display unit 220, or determine that an acceptance operation may be performed without displaying the undisplayed main information. The auxiliary information is created based on the result of counting the number of banknotes (valuable media) at the recognition unit 55, and has a simplified content such as only the total amount of each currency or only the total number of banknotes in each currency (see FIG. 8), or may be in a form of a reduced display showing information 76 on the number of banknotes for each denomination of the currency, created based on counting the number of banknotes at the recognition unit 55 (see FIG. 9). Therefore, the operator, after obtaining the auxiliary information, may check the actual main information, or may determine from the auxiliary information that no checking is needed, and accept the transaction without displaying the main information.

If the fourth aspect described above is employed, in which, if none of the main information has been displayed on the operation/display unit 70 and/or the external display unit 220 or only a part of the main information has been displayed, acceptance of a transaction inputted from the operation/display unit 70 is rejected, which indicates that none of the main information has been displayed on the operation/display unit 70 and/or the external display unit 220, or only a part of the main information has been displayed (see FIGS. 10 and 11), the operator's acceptance of the transaction is forcibly prevented. This helps all of the main information be displayed on the operation/display unit 70 and/or the external display unit 220 without fail.

If an aspect is employed in which the transaction would “never” be accepted if at least a part of the main information has not been displayed on the operation/display unit 70, all of the main information may be displayed on the operation/display unit 70 and/or the external display unit 220 without fail. If the fourth aspect is modified so that the transaction may be rejected at least once but may be accepted after a predetermined process is performed, the operator may determine whether all of the main information needs to be displayed on the operation/display unit 70 and/or the external display unit 220, or the transaction may be accepted without displaying all of the main information on the operation/display unit 70 and/or the external display unit 220. Such a flexible management is available.

If the fourth aspect with a first mode and a second mode, which are switchable, is employed, the first mode being a mode in which, if none of the main information has been displayed on the operation/display unit 70 and/or the external display unit 220 or only a part of the main information has been displayed, acceptance of a transaction inputted from the operation/display unit 70 is rejected, and the second mode being a mode in which acceptance of a transaction inputted from the operation/display unit 70 is accepted even if at least a part of the main information has not been displayed on the operation/display unit 70 and/or the external display unit 220, the first mode may be selected to preferentially display all of the main information on the operation/display unit 70 or the external display unit 220, or the second mode may be selected to preferentially perform a transaction acceptance operation immediately. Such a flexible choice of operation is advantageous.

If the main information includes information on the currency counted by the recognition unit 55 (for example, US dollar, Chinese yuan, or Euro), information on each currency counted by the recognition unit 55 may be basically displayed at least once on the operation/display unit 70 and/or the external display unit 220. This may prevent the operator from accepting a transaction without checking count information on a currency when there is a possibility that banknotes (valuable media) of a plurality of currencies are handled at a time.

If the main information includes information on denominations of banknotes counted by the recognition unit 55 (for examples, one (dollar or yuan), two (dollars), five (dollars, yuan, or euros), the operation/display unit 70 and/or the external display unit 220 may basically display information on each denomination of banknotes counted by the recognition unit 55 at least once. Therefore, if a transaction involves banknotes (valuable media) for various denominations, the operator may be prevented from accepting the transaction without checking the count information on each denomination.

If the main information includes information on denominations (for example, one dollar, two dollars, five dollars, one yuan, five yuan, five euros, and 10 euros) of the currencies (for example, US dollar, Chinese yuan, and Euro) counted by the recognition unit 55, the operation/display unit 70 and/or the external display unit 220 may be configured to basically display, at least once, information on all of the denominations of banknotes of all of the currencies counted by the recognition unit 55. Therefore, if it is possible to handle banknotes (valuable media) of a plurality of currencies at a time, and a transaction relating to banknotes (valuable media) for several denominations is performed, the operator may be prevented from accepting the transaction without checking the count information on each denomination of each currency. If the main information includes information on the number of banknotes for each denomination of the currencies counted by the recognition unit 55, the operator may be guided to check the number of banknotes for each denomination of each currency. The operator may be requested to check the number of banknotes for each denomination.

If an aspect is employed, in which only information relating to the currency counted by the recognition unit 55 is displayed on the operation/display unit 70 and/or the external display unit 220, but information relating to the currency not counted by the recognition unit 55 is not displayed on the operation/display unit 70 and/or the external display unit 220 (see FIG. 11), the operator may check, at a glance, which currency is counted by the recognition unit 55 since information on the currency not counted by the recognition unit 55 is not displayed on the operation/display unit 70 and/or the external display unit 220. Since the information on the currency not counted by the recognition unit 55 is not displayed on the operation/display unit 70 and/or the external display unit 220, the operator may be prevented from needlessly pressing down the button 71 for switching between the currencies, or needlessly scrolling the contents displayed on the window 79 showing count information for each denomination.

If an aspect is employed, in which only information on the denominations of banknotes counted by the recognition unit 55 is displayed on the operation/display unit 70 and/or the external display unit 220, and no information on the denominations of banknotes not counted by the recognition unit 55 is displayed on the operation/display unit 70 and/or the external display unit 220 (see FIG. 12), the information on the denominations displayed on the operation/display unit 70 and/or the external display unit 220 may be made minimum. Therefore, the possibility may be increased that all of the information on the denominations of banknotes counted by the recognition unit 55 may be displayed without scrolling the display of the operation/display unit 70 and/or the external display unit 220. Therefore, there may be no undisplayed information on the denominations (a part of the main information).

If at least a part of the main information has not been displayed on the operation/display unit 70, and a notice of the undisplayed main information is displayed from the beginning (immediately after the counting process in the target transaction is finished), the operator may become aware of the presence of undisplayed main information besides the main information currently displayed on the operation/display unit 70 and/or the external display unit 220 at the time the counting process is finished. This is advantageous. If at least a part of the main information has not been displayed on the operation/display unit 70 and/or the external display unit 220, and a notice indicating that there is undisplayed main information is displayed on the operation/display unit 70 and/or the external display unit 220 when acceptance of the transaction is inputted, the operator may easily understand why the transaction is rejected since the display of the operation/display unit 70 and/or the external display unit 220 changes when an input is made from the operation/display unit 70 and/or the external input unit 210 so that guidance information, character information 75, or auxiliary information is displayed. Thus, the operator may intuitively understand what needs to be done next since the guidance information, the character information 75, or the auxiliary information is displayed on the operation/display unit 70 and/or the external display unit 220 when a transaction is to be accepted.

If an aspect is employed, in which even if at least a part of the main information has not been displayed, but the transaction is accepted without displaying the undisplayed main information on the operation/display unit 70, the transaction is accepted without the operator's visually checking the main information. However, the checking of the main information is not always needed for all the transactions, and some transactions may be accepted without the operator's visually checking the main information. If the operator is forced to visually check the main information in these transactions, the work efficiency lowers. According to the embodiment, the needless reduction in work efficiency may be prevented since the visual checking may be arbitrarily omitted for selected transactions.

The disclosures in the descriptions of the embodiment and the drawings indicate mere examples for explaining claimed inventions, and thus do not limit the scope of the claimed inventions.

### EXPLANATION OF REFERENCES

10: taking-in unit
20: transport unit
40: tracking sensor
41: presence detection sensor
42: presence detection sensor
45: diverter
60: stacker
61: rejection unit
55: recognition unit
56: memory unit
70: operation/display unit (display unit, input unit)
70a, 70b: operation display screen
80: switching unit
71: button for switching between currencies
71a: button for displaying information on US dollar
71b: button for displaying information on Chinese yuan
71c: button for displaying information on Euro
72a: upward arrow
72b: downward arrow
73: “ACCEPT” button
74: “CLEAR” button
75: character information
76: information on the number of banknotes for each denomination of a currency displayed in a reduced manner
79: window showing count information for each denomination
110: imaging unit
120: image memory unit
130: image display unit
200: external machine
210: external input unit
220: external display unit
230: external memory unit

1. A valuable medium handling system configured to handle a valuable medium, comprising:
a recognition unit configured to recognize and count the valuable medium; and
a display unit configured to display count information resulted from counting of the valuable medium performed by the recognition unit,
wherein if at least a part of the count information has not been displayed on the display unit, a notice indicating undisplayed count information is provided.

2. The valuable medium handling system according to claim 1, wherein if at least a part of the count information has not been displayed on the display unit, guidance information is displayed on the display unit, the guidance information being used to display the undisplayed count information on the display unit.

3. The valuable medium handling system according to claim 1, wherein if at least a part of the count information has not been displayed on the display unit, character information notifying of the undisplayed count information is displayed on the display unit.

4. The valuable medium handling system according to claim 1, wherein the count information includes information on a currency counted by the recognition unit.

5. The valuable medium handling system according to claim 1, wherein the count information includes information on the number of banknotes for each denomination of a currency count by the recognition unit.

6. The valuable medium handling system according to claim 4, wherein information on a currency counted by the recognition unit is displayed on the display unit in a different manner from information on a currency not counted by the recognition unit.

7. The valuable medium handling system according to claim 1, wherein the count information includes information on denominations of money counted by the recognition unit.

8. The valuable medium handling system according to claim 1, wherein the count information includes information on the number of banknotes for each denomination of money counted by the recognition unit.

9. The valuable medium handling system according to claim 7, wherein information on a denomination counted by the recognition unit may be displayed on the display unit in a different matter from information on a denomination not counted by the recognition unit.

10. The valuable medium handling system according to claim 1, wherein if at least a part of the count information has not been displayed on the display unit, auxiliary information including a content that is not included in the count information, or having an aspect that is different from that of the count information is displayed on the display unit.

11. The valuable medium handling system according to claim 1, further comprising an input unit for inputting acceptance of a transaction,
wherein if at least a part of the count information has not been displayed on the display unit, and the acceptance of the transaction is inputted from the input unit, a notice indicating that there is undisplayed count information is provided.

12. The valuable medium handling system according to claim 11, wherein if the acceptance of the transaction is inputted from the input unit after the notice indicating that there is the undisplayed count information is provided, the transaction is accepted despite of the undisplayed count information.

13. The valuable medium handling system according to claim 12, wherein if the transaction is accepted despite of the undisplayed count information, a notice is displayed on the display unit.

14. The valuable medium handling system according to claim 1, further comprising an input unit for inputting acceptance of a transaction,
wherein if at least a part of the count information has not been displayed on the display unit, acceptance of a transaction inputted from the input unit is not accepted, which indicates that the part of the count information has not been displayed on the display unit.

15. The valuable medium handling system according to claim 14, further comprising a switching unit having a first mode in which the acceptance of the transaction inputted from the input unit is rejected if at least a part of the count information has not been displayed on the display unit, and a second mode in which the acceptance of the transaction is accepted even if at least a part of the count information has not been displayed on the display unit.

16. The valuable medium handling system according to claim 15, wherein if, in the second mode, there is the undisplayed count information and the acceptance of the transaction is accepted, a notice relating to the acceptance is displayed on the display unit.

17. A valuable medium handling method for handling a valuable medium, comprising:
recognizing and counting the valuable medium by a recognition unit;
displaying, by a display unit, count information resulted from counting of the valuable medium by the recognition unit; and
providing a notice if at least a part of the count information has not been displayed on the display unit.
